(19) United States
(12) Patent Application Publication
(10) Pub. No.: US 2014/0338830 A1
(43) Pub. Date: Nov. 20, 2014

(54) COMPOSITE ENHANCEMENT

(71) Applicant: Duracote Corporation, Ravenna, OH (US)

(72) Inventor: John A. Petroski, Ravenna, OH (US)

(21) Appl. No.: 14/282,656

(22) Filed: May 20, 2014

Related U.S. Application Data
(60) Provisional application No. 61/825,242, filed on May 20, 2013.

(51) Int. Cl. C09D 1/02; B05D 1/18; B05D 1/40; B05D 1/36; B32B 37/12; B05D 1/26; B05D 1/28; B05D 1/02

(52) U.S. Cl. CPC C09D 1/02; B05D 1/28; B05D 1/18; B05D 1/02; B05D 1/36; B32B 37/1284; B05D 1/265; B05D 1/40; B32B 2305/08; B32B 2307/3065
USPC 156/278; 427/428.06; 427/428.11; 427/430.1; 427/427; 427/209; 427/208; 427/402; 428/454; 428/446; 428/428; 428/408; 442/136; 428/425.5; 428/354; 428/451

(57) ABSTRACT

Provided is a composite laminate including an inorganic layer and a composite reinforcement layer. Further provided is a method for coating a first composite laminate with an inorganic layer including the step of applying an inorganic layer to a composite reinforcement layer of a first composite laminate.

### TECHNICAL FIELD

This invention relates to the enhancement of composite laminates, specifically in greatly improving fire resistance.

### BACKGROUND

With more widespread use of composite laminates it has become apparent that they may be prone to ignition when exposed to low heat flux fire, and even when the ignition source is removed, the composites may support combustion. This is problematic for certain industries such as aerospace and surface transportation where egress from a burning structure, such as an aircraft fuselage or an underground railcar, may be restricted.

Composite laminates are typically composed of layers of reinforcing fabric saturated with a resin that acts as an adhesive for the plies. The majority of fabric reinforcements are either fiberglass or carbon fiber. The fiberglass and carbon fabrics normally are not prone to combustion. The resin systems used to bond the layers of reinforcing fabric are usually based on epoxy, vinyl ester or phenolic resins. It is the resin systems that may be susceptible to combustion, especially those based on epoxy and vinyl esters. While phenolic resins are more resistant to burning, this invention would likely provide increased protection from damage as the result of fire.

The Federal Aviation Administration (FAA) is currently developing fire test methods to quantify fire resistance of composite laminates. While a method has not yet been standardized, development is proceeding on a method where the composite laminate is exposed to a low level heat flux generated by a radiant heat source augmented by an open flame. This radiant heat is intended to simulate a low level fire in an inaccessible area of an aircraft. This radiant heat exposure penetrates into the laminate causing the low molecular weight components of the resin systems to volatilize and migrate to the surface of the outer layer. A secondary heat source in the form of gentle open flame is designed to ignite these volatiles. Once a flame has been generated by the burning volatiles the heat of combustion supports further volatilization, until the fuel source has exhausted or there is no longer sufficient penetrating heat to promote volatilization.

### SUMMARY

Provided is a composite laminate including an inorganic layer and a composite reinforcement layer. Further provided is a method for coating a first composite laminate with an inorganic layer including the step of applying an inorganic layer to a composite reinforcement layer of a first composite laminate.

### BRIEF DESCRIPTION OF THE DRAWINGS

FIG. 1 is a diagram of an exemplary composite laminate;

FIG. 2 is a diagram of an alternative embodiment of the composite laminate;

FIG. 3 is a diagram of another alternative embodiment of the composite laminate;

FIG. 4 is a diagram of another alternative embodiment of the composite laminate;

FIG. 5 is a chart of results from the modified radiant panel test.

### DETAILED DESCRIPTION

One embodiment involves the coating of inorganic materials and a means of incorporating them into composites under typical laminating conditions.

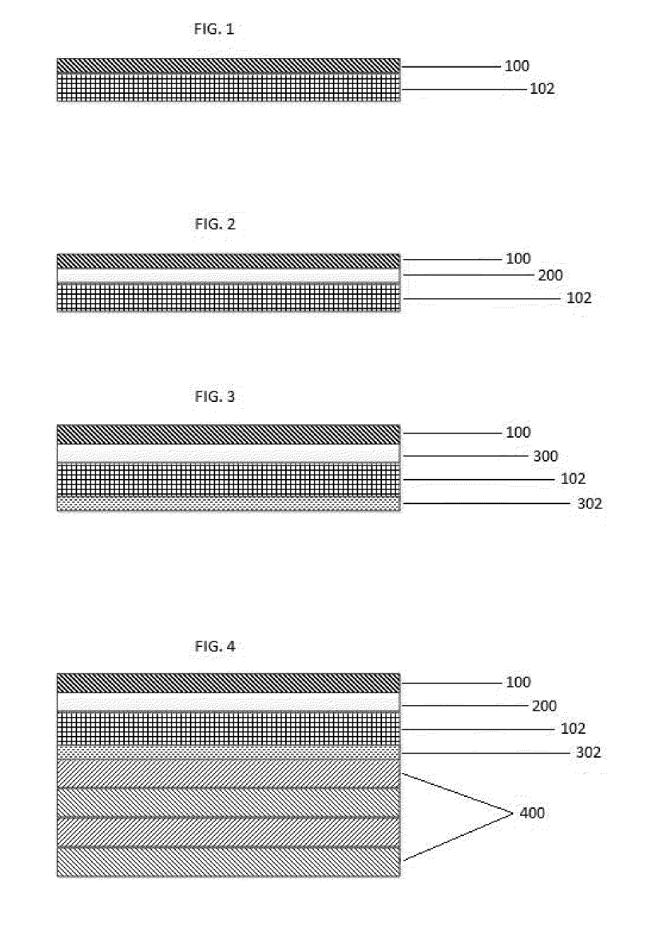

With reference to FIG. 1, one embodiment of the current invention is a composite reinforcement layer 102 comprising woven glass fabric (fiberglass), including, but not limited to, Style 106 or Style 120. The specifications of the various fiberglass styles are known to a person of ordinary skill in the art as the various style numbers represent an industry wide standard specification. The composite reinforcement layer 102 is coated with an inorganic layer 100. The inorganic layer 100 can be a film or a continuous layer which acts as a fire barrier and does not support combustion. The inorganic layer 100 comprises a fire resistant coating and could be based on polyamide, polyimide or silicone chemistries. One embodiment includes an inorganic layer 100 that could be totally inorganic in nature such as mica or vermiculite. Mica and vermiculite can be totally free of organics, do not support combustion, can be heat reflective and are very effective fire barriers. Being inorganic, mica and vermiculite do not require secondary fire retardants, which make them very attractive for applications requiring low smoke and toxic by-product generation, and reduce the likelihood of future environmental regulation.

The inorganic layer 100 can be a water-based mica or vermiculite slurry. One embodiment of the inorganic layer 100 is vermiculite due to its flexible, film forming nature once dried. Film formation and integrity are promoted by the attraction of platelets to each other and the “shingling” formation where platelets are staggered over each other in layers. While the inorganic slurries may contain organics to aid in surface adhesion or to promote water resistance it may be desired to avoid organics if the intended application will require exposure to temperatures greater than 300° F. High temperature exposure may degrade organics in the coating, causing voids and weakening the integrity of the inorganic material. Examples of vermiculite slurries include those sold under the trade name “Microlite Dispersion” by Specialty Vermiculite Corporation. One of these “Microlite Dispersion” vermiculite slurries could be 963 and 963HS. In addition, both muscovite and phlogopite micas can be used to enhance fire protection, with phlogopite having a higher heat resistance. An example of a phlogopite mica slurry would be, but not limited to Kish Company's “HR series.”

The inorganic layer 100 may be applied by several coating methods including gravure roll, reverse roll, Meyer rod, knife, dip, spray, or extrusion. These coating techniques are known to those of ordinary skill in the art. In an exemplary embodiment, the inorganic layer 100 is concentrated to the side of the composite reinforcement layer 102 that is expected to be exposed to high heat. In alternate embodiments, the inorganic layer 100 can be applied to both sides of the composite reinforcement layer 102. The inorganic layer 100 can be applied in a single pass coating or in multiple pass coatings to achieve a coating thickness and/or weight that would provide suitable performance depending on the desired application.

In addition to woven glass fabric, the composite reinforcement layer 102 could include, but is not limited to, carbon fiber or fire resistant synthetics such as aromatic polyamide (NOMEX) or oxidized polyacrylonitrile (PAN). These fabrics may be in a discrete woven form or in a nonwoven mat or felt.

With reference to FIG. 2, alternative embodiments may include instances where greater adhesion of the inorganic layer 100 to the composite reinforcement layer 102 is required. An example would be for a tightly woven composite reinforcement layer 102 where the inorganic layer 100 cannot achieve mechanical bonding by means of penetration. In these cases it can be advantageous to coat an adhesion promoting tie layer 200 onto the glass prior to coating the composite reinforcement layer 102 with the inorganic layer 100. Heat activated coatings can be very useful to promote anchorage. They may be based on acrylic or polyurethane or a blend of both. The heat activated tie layer 200 is applied to the composite reinforcement layer 102 and allowed to dry and cool to a tack free state. The inorganic layer 100 can then be coated on top of the tie layer 200 and dried. At the end of the drying process it is important to reach the heat activation temperature of the tie layer 200 so it can be activated and promote a strong bond. The proper temperature for heat activation of the tie layer 200 varies dependent on the chosen adhesive. Such temperature would be easily determined by one of ordinary skill in the art.

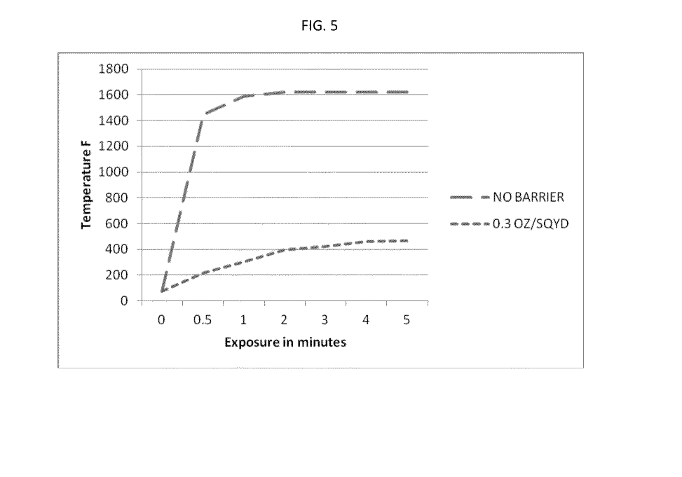

With reference to FIG. 3, an inorganic tie layer 300 is used for very high temperature applications. An example of a suitable inorganic tie layer 300 would be sodium silicate. In this embodiment the inorganic tie layer 300 and inorganic layer 100 may be applied in line. In this embodiment, an inorganic tie layer 300 comprised of sodium silicate should not be completely dried prior to coating with the inorganic layer 100. Not fully drying the sodium silicate inorganic tie layer 300 leaves a wet tack that functions to promote adhesion with the inorganic layer 100.

With reference to FIGS. 3 and 4, an enhancing embodiment of the constructions disclosed in the previous embodiments includes a suitable structural adhesive 302 that is applied to the backside of the composite reinforcement layer 102. An example of such an adhesive would be an epichlorohydrin/bisphenol A liquid epoxy resin, such as Dow Chemical Company's “DER 331” cured with a dicyanamide, such as Air Products “Amicure CG-1200G Curing Agent.” As an alternative to this exemplary embodiment, “B-Staged” epoxies and phenolics could also be used. Further, since it already has a suitable adhesive system applied to the backside, the composite manufacturer simply replaces the outer most ply of a composite 400 with the entire structure comprising the inorganic layer 100, the composite reinforcement layer 102, the tie layer 200 or the inorganic tie layer 300, if either is warranted given the particulars of the desired application, and the structural adhesive 302. Handling and curing the resulting composite would not require special effort by the manufacturer, as the replacement easily adopting to typical manufacturing processes.

With continued reference to FIG. 4, composites 400 are typically layers of reinforcing fabrics that are wet laid using structural adhesives such as epoxies or phenolics. An example could be 4 to 35 layers of 120 Style glass saturated with a liquid epoxy adhesive. The stack of reinforcing fabrics saturated with adhesive can be cured by pressing between heated plates in a press or compressed in a vacuum bag then cured in an autoclave.

Embodiments of the claimed invention could be introduced in the typical composites manufacturing process. In the case of a typical multiple layer/ply composite laminate, any of the disclosed embodiments could be substituted for the outer most ply of a composite 400. The embodiment should be positioned so that the inorganic coated side is away from the other plies. The inorganic layer 100 could be located between the fire source and the body of the laminate to maximize fire protection by limiting heat transfer and volatilization of organics in the laminate body. The inorganic layer 100 has an unusually high degree of heat reflection which further functions to reduce the internal temperature of a composite laminate's volatile resin, thereby limiting the fuel source through prevention of volatilization of the laminate's combustible components.

There is not a recognized test standard for fire testing composites, therefore a test that is more aggressive than the test under development by the FAA, was chosen to approximate the fire sequence.

In 14 CFR §25.856 a test is specified for aircraft insulation blankets, also known as a Radiant Panel Test. This Radiant Panel Test exposes a sample to a radiant heat source, which promotes volatilization of flammable substances, and a high temperature gas torch which drops down over the sample surface for 15 seconds to ignite any flammable vapors. The test was adjusted so that the radiant heat flux would expose the test sample to temperatures of 400° F. To increase the severity of the torch exposure, the dwell time was increased from 15 seconds to 60 seconds.

Composite test plaques were ⅛″ thick consisting of 32 plies of 120 glass saturated with an Epon 828 epoxy resin system. Test plaques measured approximately 4″×6″.

When a glass/epoxy plaque was exposed to the modified radiant panel test, in less than 30 seconds heavy smoke was generated, followed by an intense flame front ignited above the plaque's surface. This indicated volatiles were being generated by exposure to radiant heat and ignited by the gas torch. When the torch was removed after one minute the fire continued to grow. The burning plaque was moved to the end of the chamber, away from heat sources, where it continued to self-support combustion, vigorously burning for 5 minutes, until the fire was extinguished.

This scenario was repeated except a piece of 106 glass with an inorganic coating with a weight of approximately 0.3 oz./yd² was placed on top of the new plaque. Following the same heating conditions, after one minute of torch exposure, there was no indication of any ignition or fire. This example proves the benefit of the inorganic coating's ability to protect the underlying composite plaque from damaging heat and ignition.

Further proof of the inorganic coating's resistance to fire, also demonstrates its ability to reflect heat. A Bunsen burner was adjusted for a flame 1.5″ in length with a temperature of approximately 1600° F. A sample of 106 glass with an inorganic coating weight of approximately 0.3 oz/yd² was suspended horizontally directly above the flame tip. A thermocouple was placed 1″ above the backside of the sample. The inorganic coating demonstrates its ability to not only resist combustion but to reflect heat from its surface. This provides an understanding for the reason it performed well in protecting the composite plaque during the radiant panel test.

With reference to FIG. 5, as evidenced by the data, the exposed thermocouple rapidly senses heat reading 1600° F. in approximately one minute. However, when the sample of inorganic coated glass is placed in front of the flame, heat transferred through the sample gradually reaches 400° F. after two minutes then shows little heat increase even after five minutes.

While the composite enhancement has been described in connection with various illustrative embodiments, it is to be understood that other similar embodiments may be used or modifications and additions may be made to the described embodiments for performing the same function disclosed herein without deviating therefrom. Further, all embodiments disclosed are not necessarily in the alternative, as various embodiments may be combined or subtracted to provide the desired characteristics. Variations can be made by one having ordinary skill in the art without departing from the spirit and scope hereof. Therefore, the composite enhancement should not be limited to any single embodiment, but rather construed in breadth and scope in accordance with the recitation of the appended claims.

Having thus described the invention, it is now claimed:

I/we claim:

1. A composite laminate comprising:
a. an inorganic layer; and
b. a composite reinforcement layer.

2. The composite laminate of claim 1 wherein said inorganic layer further comprises mica.

3. The composite laminate of claim 1 wherein said inorganic layer further comprises vermiculite.

4. The composite laminate of claim 2 wherein said mica is muscovite or pholgopite.

5. The composite laminate of claim 1 where said composite reinforcement layer is selected from a group consisting of fiberglass, carbon fiber, aromatic polyamide, and oxidized polyacrylonitrile.

6. The composite laminate of claim 1 wherein said composite reinforcement layer is woven.

7. The composite laminate of claim 1 wherein said composite reinforcement layer is a non-woven mat or felt.

8. The composite laminate of claim 1 further comprising a heat activated tie layer between said inorganic layer and said composite reinforcement layer.

9. The composite laminate of claim 8 wherein said heat activated tie layer comprises acrylic, polyurethane, or a blend of both.

10. The composite laminate of claim 8 wherein said heat activated tie layer comprises an inorganic adhesive.

11. The composite laminate of claim 10 wherein said inorganic adhesive further comprises sodium silicate.

12. The composite laminate of claim 8 further comprising a structural adhesive on the back side of said composite reinforcement layer.

13. The composite laminate of claim 1 further comprising a structural adhesive on the back side of said composite reinforcement layer.

14. The composite laminate of claim 13 wherein said structural adhesive further comprises an epichlorohydrin/bisphenol A epoxy resin cured with a dicyanamide curing agent.

15. A method of coating a first composite laminate with an inorganic layer comprising the step of applying an inorganic layer to a composite reinforcement layer of a first composite laminate.

16. The method of claim 14 wherein applying said inorganic layer is performed by gravure roll, reverse roll, Meyer rod, knife, dip, spray, or extrusion.

17. The method of claim 15 further comprising the step of applying said inorganic layer to both sides of the composite reinforcement layer.

18. The method of claim 15 further comprising the step of coating said composite reinforcement layer with a tie layer prior to applying said inorganic layer.

19. The method of claim 15 further comprising the step of applying a structural adhesive to the backside of said composite reinforcement layer.

20. The method of claim 19 further comprising the step of securing said first composite laminate to a second composite laminate using said structural adhesive.
